(19) United States
(12) Patent Application Publication
(10) Pub. No.: US 2003/0074201 A1
(43) Pub. Date: Apr. 17, 2003

(54) Continuous authentication of the identity of a speaker

(75) Inventors: Stephan Grashey, Olching (DE); Wolfgang Kuepper, Munich (DE)

Correspondence Address: STAAS & HALSEY LLP, 700 11TH STREET, NW, SUITE 500, WASHINGTON, DC, 20001, US

(73) Assignee: Siemens AG, Munich (DE)

(21) Appl. No.: 10/268,089

(22) Filed: Oct. 10, 2002

(30) Foreign Application Priority Data
Oct. 11, 2001 (DE) 101 50 108.0

(51) Int. Cl. G10L 11/00

(52) U.S. Cl. 704/273

(57) ABSTRACT

The identity of a person is authenticated continuously by speech signals which are included in a multiplicity of phrases spoken by the person.

### CROSS REFERENCE TO RELATED APPLICATIONS

This application is based on and hereby claims priority to German Application No. 101 50 108.0 filed on Oct. 11, 2001, the contents of which are hereby incorporated by reference.

### BACKGROUND OF THE INVENTION

1. Field of the Invention

The invention relates to a method for authenticating the identity of a person, in which the authentication of identity is performed using speech signals, as well as to a system which is designed to carry out the method.

2. Description of the Related Art

There are various possible ways of authenticating the identity of a calling, unknown person when making a telephone call:

the telephone number of the caller is checked by reading the telephone display or possibly by calling back,

the person must say a secret code word, or

the person must specify a personal PIN (Personal Identification Number), customer number etc. known only to him.

All these methods entail problems. It is not ensured that the telephone number is transferred to all other parties to a telephone call. Code words and code numbers may be stolen or forgotten. The aforesaid methods also do not check the actual identity of the person but rather only the use of a specific phone connection, or whether the person has particular knowledge.

These problems may be remedied by biometric methods, for example, speaker recognition. Here, the person is recognized from the sound and the dynamics of his voice. In the customary application of speaker recognition, the person must speak a particular predefined text, typically at the start of the conversation. This may be, for example, the personal customer number, identification taking place by the customer number with simultaneous checking of the authorized use of this number using a speaker verification process. The authentication of identity is thus terminated.

Such a procedure has, however, the disadvantage that it is necessary, by a correspondingly configured dialog prompting process to ensure that the person speaks the speech signal necessary for authentication of identity at a suitable point. This prevents natural communication.

### SUMMARY OF THE INVENTION

An object of the invention is to make speaker recognition more reliable, in particular when making a telephone call, and simultaneously to restrict to a lesser degree the natural flow of speech of the person whose identity is to be authenticated.

According to the invention, the identity of a person is authenticated using speech signals. As used herein, authentication of identity is the identification and/or verification of a person. In this process, the person speaks, in particular during a communication with another party to the communication, a multiplicity of phrases in the form of sentences or independent utterances which do not need to have the grammatical structure of sentences, but are comparable in the scope of their contents. Using the speech signals which are spoken for the phrases by the person, authentication of identity is then performed repeatedly during the communication, or essentially in a continuous process. The speaker recognition is therefore not carried out once at the start of a conversation but rather continuously during the continuing conversation or the phrases spoken by the person.

The continuous authentication of identity can take place without interruption with very high security requirements. However, as a rule it is sufficient to carry out the continuous authentication of identity by performing the authentication of identity of the person repeatedly on sections of the phrases or voice signals.

How large these sections are in comparison to the multiplicity of phrases spoken in total can preferably be set by predefinable security levels. It is conceivable here, for example, for authentication of identity to be performed on at least 1/10, ⅓, half, ⅔, ¾ or ⅘ of the speech signals spoken for the phrase.

Instead of over a chronological portion of the sections, it is also possible to control in terms of content which of the spoken speech signals will be taken into account in the continuous authentication of identity. If, in fact, the authentication of identity of the person is necessary only for specific contents, the authentication of the identity of the person is preferably performed using the speech signals which contain the contents themselves or which are composed of the contents themselves which require the authentication of identity of the person.

In particular, the authentication of identity of the person is performed using speech signals which are not output by the person for the purpose of authentication of identity.

During the continuous authentication of identity of the person using speech signals, that is to say during the continuous speaker recognition process, it is possible to operate with a predefined speaker model by which the identity of the person is authenticated or is not authenticated. The speaker model contains, for this purpose, reference patterns which are compared with test patterns acquired from the voice signals by preprocessing.

Instead of a predefined speaker model, it is, however, also possible to create, from the speech signals spoken by the person at the start or intermediately during the communications process, a speaker model which is used to authenticate the identity of subsequent speech signals of the same communication process. To create the speaker model from speech signals spoken at the beginning, the speech signals are chosen to be long and numerous enough for a transient-recovery phase to be passed through, that is to say for the speaker model to be set and a change of intonation and changes in the manner of speaking of the person to be taken into account. Although this method does not permit absolute authentication of identity of the speaker, it certainly permits a relative one. Thus it is possible to determine whether a speaker has changed during the conversation or else which of a plurality of participants in a conversation is speaking at a particular time. The alternative mentioned first can be used, for example, to detect hijackings of airplanes by monitoring the conversation between the pilot and the tower.

The communication process may be here a conversation, for example in the form of a dialog, or else a one-sided speech input of information.

Furthermore, the method preferably uses a novelty detector by which a change of speaker is detected. The novelty detector operates in particular with a latency time. This means that the speech signals may deviate from the reference patterns over a predefined tolerance time period, specifically the set latency time, to such an extent that the identity of the person is not actually authenticated. Only if the deviation persists beyond the latency time does the novelty detector produce an output confirming that a change of speaker has occurred. Thus, brief changes in the manner of speaking of the person or imperfections in the reference patterns are compensated.

According to an object of the invention, the phrases of the person are not predefined but rather they can formulate the contents which they express in free speech without having to comply with a syntax which is necessary for the authentication of identity. Correspondingly, the phrases are preferably free or flowing speech.

In accordance with the original intention, the method can be used particularly advantageously if the person communicates with another party to the communication using a telecommunications device, in particular a telephone, and for that purpose the speech signals are transferred via the telecommunications device.

A system which is designed to carry out one of the previously described methods may be implemented, for example, by correspondingly setting up and programming a data processing system with an input unit to receive speech signals, and a processor to process the speech signals and continuously or repeatedly authenticate the identity of the person. Such a system may have, for example, a connection to a telecommunications device or contain a telecommunications device.

### BRIEF DESCRIPTION OF THE DRAWINGS

These and other objects and advantages of the present invention will become more apparent and more readily appreciated from the following description of the preferred embodiments, taken in conjunction with the accompanying drawings of which:

FIG. 1 is a block diagram of a system for continuously or repeatedly authenticating the identity of a person in connection with a telecommunications device.

### DETAILED DESCRIPTION OF THE PREFERRED EMBODIMENT

Reference will now be made in detail to the preferred embodiments of the present invention, examples of which are illustrated in the accompanying drawings, wherein like reference numerals refer to like elements throughout.

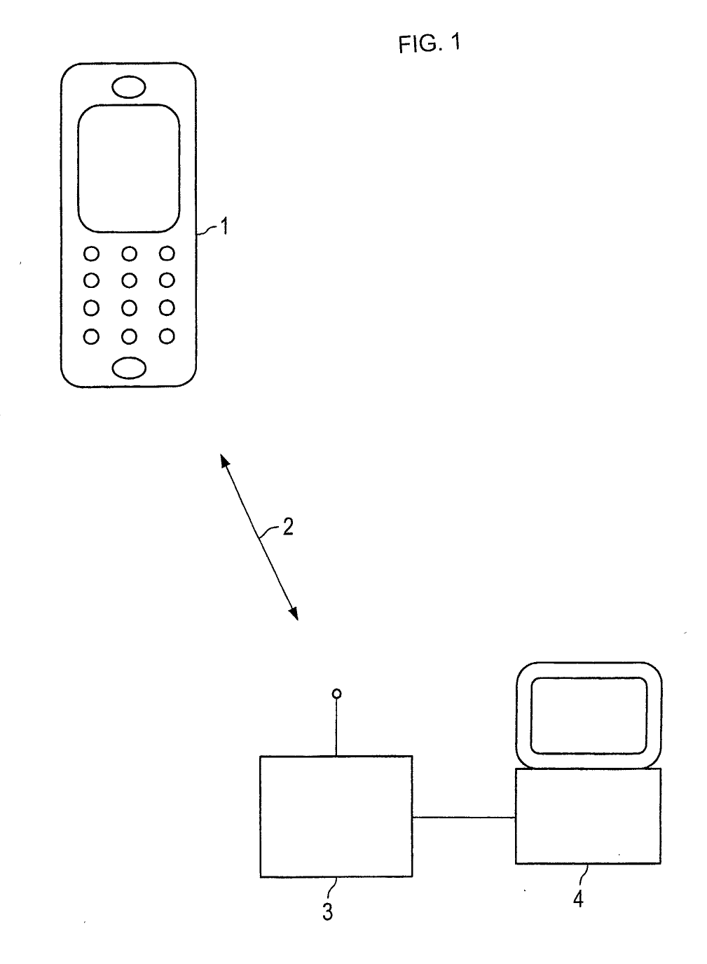

In FIG. 1, a mobile telephone 1 records the speech signals of a person and sends them to base station 3 via radio transmission path 2. From base station 3, the speech signals are passed on to computer 4 of a call center which, on the one hand, outputs the speech signals by headsets or loudspeakers or electronically further processes them and, on the other hand, performs authentication of the identity of the speaking person using the speech signals.

The person calls the call center, using for example using the mobile telephone 1, in order to be able to process and dispatch trade orders or carry out telephone banking. In order to exclude the possibility of misuse by third parties, it is absolutely necessary for the identity of the person to be authenticated here.

As soon as the connection has been established and speech signals which represent the phrases spoken by the person are transmitted, the automatic speaker recognition is started on the computer 4. Generally, the person will have to give his name or customer number to the call center so that the speaker can be identified by reference to this information. The identity of the person which is to be determined is obtained in this way or, alternatively, by biometric speaker identification, speech recognition by detecting of the name or the customer number of the person, the information stored electronically in a smart card or some other portable medium, or for example a suitable default assumption. The default assumption can be used, for example, in the mobile telephone 1 or a PDA (Personal Digital Assistant) which is used additionally or instead. The initial identification of the person can take place by speaker identification, speech recognition, electronically stored information or default assumption. The result of the speaker identification is used in the subsequent verification.

When the party to the conversation is human, the result of the continuous verification is in turn indicated in some suitable way on the computer 4 or transferred to a dialog system for processing. If the verification was successful, the person is not aware of it at all; but if the verification fails, suitable measures are taken on the computer 4 by the service provider. Such a measure may be, for example the need for a personal appearance by the person.

The authentication of identity takes place continuously in the background, that is to say without an explicit request to speak a specific identity-authentication text, and makes use of the flowing, free speech of the person whose identity is to be authenticated during the conversation. For this purpose, after a relatively long transient-recovery phase, the parameters of a speaker model are checked for deviations by a novelty detector with a suitable latency time. Here, the novelty detector compares the correspondence of the extracted parameters with those of the speaker model.

The certainty of the speaker recognition, that is to say the incorrect acceptance rate in comparison with the incorrect rejection rate, can be suitably selected or set according to a situation of use.

The method is not restricted to a one-sided application but rather can also be used to perform mutual authentication of identity for a plurality of parties to a conversation.

The method described is also suitable for authenticating the identity of a person speaking when telephone lines are tapped. As a result, it is not only possible to ensure that the correct person is monitored but also to prevent unauthorized tapping, which makes a contribution to data protection.

As the authentication of identity with the method described is not carried out only once at the beginning, it is possible to determine whether the identity of the speaker changes during the course of the conversation. It is thus possible, for example, to fend off replay attacks in which a sound recording is played for false authentication of identity.

The method generally provides a simple and reliable way of authenticating identity and providing verification: instead of a PIN being input or a code word being spoken or as an alternative, in addition, the authentication of identity is carried out by speaker recognition in the form of speaker verification or speaker identification. Thus, the actual identity of a person can be determined.

The repeated authentication of identity ensures the identity of the person during the entire conversation.

It is possible to dispense with a dialog element which is tailored to the identity authentication.

A code number or code word are replaced by biometrics in the form of speaker identification or verification. As a result, knowledge, which can also be acquired by an unauthorized person, is no longer requested but rather the identity of the person is checked using physical features and characteristic aspects of behavior such as sound and dynamics of the voice.

The invention has been described in detail with particular reference to preferred embodiments thereof and examples, but it will be understood that variations and modifications can be effected within the spirit and scope of the invention.

What is claimed is:

1. A method for authentication of a person, comprising:
authenticating the person using speech signals produced when the person speaks a plurality of phrases interspersed in words spoken by the person.

2. The method as claimed in claim 1, wherein said authenticating is performed repeatedly using the speech signals generated when the phrases are spoken by the person.

3. The method as claimed in claim 2, wherein said authenticating is performed continuously without interruption using the speech signals.

4. The method as claimed in claim 2, wherein said authenticating is performed using at least half the speech signals produced for the phrases.

5. The method as claimed in claim 4, wherein said authenticating of the identity of the person is necessary for specific contents, and the speech signals used for authentication of the identity of the person are the speech signals generated when the person speaks the phrases included in the specific contents.

6. The method as claimed in claim 5, wherein the speech signals generated by the person are not exclusively for the purpose of authentication.

7. The method as claimed in claim 6, wherein said authenticating applies a speaker model created from earlier speech signals generated from words spoken by the person during a communication process to authenticate the identity of the speaker based on later speech signals in the communication process.

8. The method as claimed in at least claim 7, wherein the earlier speech signals used to create the speaker model are received in beginning the communication process.

9. The method as claimed in claim 8, further comprising using a novelty detector to detect whether a change of speaker takes place.

10. The method as claimed in claim 9, wherein the novelty detector operates with a latency time.

11. The method as claimed in claim 10, wherein the phrases are not predefined.

12. The method as claimed in claim 11, wherein the phrases are included in at least one of free and flowing speech.

13. The method as claimed in claim 12, wherein the person communicates using a telecommunications device and the speech signals are transmitted via the telecommunications device.

14. A system for authenticating an identity of a person, comprising:
an input unit to receive speech signals produced when the person speaks; and
a processor, coupled to the input unit, to authenticate the identity of the person using the speech signals produced when the person speaks a plurality of phrases interspersed in words spoken by the person.

15. At least one computer readable medium storing at least one program to control at least one processor to perform a method for authenticating an identity of a person, said method comprising:
authenticating the identity of the person using speech signals produced when the person speaks a plurality of phrases interspersed in words spoken by the person.
